(19) United States
(12) Patent Application Publication
(10) Pub. No.: US 2023/0318811 A1
(43) Pub. Date: Oct. 5, 2023

(54) METHOD AND APPARATUS FOR VERIFYING USER CREDENTIALS

(71) Applicant: Sony Group Corporation, Tokyo (JP)

(72) Inventor: Rik CLAESEN, Stuttgart (DE)

(73) Assignee: Sony Group Corporation, Tokyo (JP)

(21) Appl. No.: 18/187,721

(22) Filed: Mar. 22, 2023

(30) Foreign Application Priority Data
Mar. 29, 2022 (EP) 22164908.0

(51) Int. Cl. H04L 9/08; H04L 67/53

(52) U.S. Cl. CPC H04L 9/0825; H04L 67/53

(57) ABSTRACT

A method and apparatus for verifying user credentials. An owner of a non-fungible token (NFT) may sign a verifiable credential with a private key associated with a cryptocurrency address holding the NFT, and then issue the verifiable credential signed with the private key to another entity. The owner of the NFT may assign a public decentralized identifier (DID) to the NFT and register the public DID on a public ledger so that anyone can look up this public DID. The NFT may be identified by the public DID. A public key corresponding to the private key is disclosed in a DID document associated with the public DID. An entity who receives the verifiable credential may obtain the public key from the DID document and verify the verifiable credential using the obtained public key.

### CROSS-REFERENCE TO RELATED APPLICATION

This application claims priority to European Application No. 22164908.0, filed Mar. 29, 2022, the entire contents of which are incorporated herein by reference.

### FIELD

Examples of the present disclosure relate to a method and apparatus for verifying user credentials.

### BACKGROUND

The Metaverse and non-fungible tokens (NFTs) seem to pave the road to a new digital economy. NFTs ensure that online goods are unique and can be linked to an owner. Today there are many upcoming metaverses like Decentraland where users can acquire digital virtual property. Ownership of a digital and virtual real-estate may be established through NFTs. Transferring ownership is done by selling the corresponding NFT in a similar way as cryptocurrency tokens (e.g., Bitcoin, Ether, etc.) are exchanged in transactions.

### SUMMARY

According to a first aspect of the present disclosure, a method and apparatus are provided for verifying user credentials. An owner of an NFT signs a verifiable credential with a private key associated with a cryptocurrency address holding the NFT. The owner may then issue the verifiable credential signed with the private key to another entity. The owner of the NFT may assign a public decentralized identifier (DID) to the NFT and register the public DID on a public ledger, and the NFT may be identified by the public DID. A public key corresponding to the private key used for signing the verifiable credential is disclosed in a DID document associated with the public DID.

According to another aspect of the present disclosure, a method and apparatus are provided for verifying user credentials. An entity receives a verifiable credential that is signed using a private key of a public key infrastructure. The private key is associated with a cryptocurrency address holding an NFT. The entity may obtain a public key corresponding to the private key and verify the verifiable credential using the obtained public key. The owner of the NFT may assign a public DID to the NFT and register the public DID on a public ledger. The entity may resolve the public DID of the NFT to a DID document and obtain the public key from the DID document. The verifiable credential may be verified if the cryptocurrency address holding the NFT can be derived from the public key.

### BRIEF DESCRIPTION OF THE FIGURES

Some examples of apparatuses and/or methods will be described in the following by way of example only, and with reference to the accompanying figures, in which

FIG. 1 illustrates an example process of verifying a user credential;

FIGS. 2 and 3 are schematic block diagrams of apparatuses for verifying user credentials in accordance with one example; and

FIGS. 4 and 5 are flow diagrams of example methods for verifying user credentials.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the Metaverse, NFTs will play an important role and it could well be that the importance of an NFT will transcend its owner. People could respect or believe that what is associated with an NFT more easily than when it is coming from a rather unknown owner of an NFT. People could also more easily identify with an NFT in the Metaverse than to identify with an owner of an NFT. A current owner of an NFT is not necessarily the same as a creator of the NFT. Therefore, the symbolic power of an NFT will often be greater than that of the owner. For example, a message coming from an NFT linked to a famous building or piece of art or well-known art will more easily be accepted than if it comes directly from an unknown owner of an NFT. For example, when an owner of a virtual piece of land would like to lease parts of it to others so they can build a house on it and hold it for a certain period of time, the owner could issue each of them a verifiable credential that would represent the deal. For another example, when an owner of digital painting would like to invite people to an art exhibition, the owner could issue verifiable credentials that serve as VIP passes. In both cases, nobody would know the owner of the NFT, but they might know the virtual property (i.e., the NFT).

In both examples above, the owner needs to prove to all interested parties that the owner indeed owns the NFT and can issue a verifiable credential (VC). Therefore, the self-sovereign ID (SSI) proofs based on the received verifiable credentials will be subject to the following verifications: 1) whether the issued VC is signed by the owner who claims to own the NFT, 2) whether the issuer of the VC really holds the NFT token, and 3) whether the issuer of the VC is who he/she claims to be.

There is also a problem if the owner, when being a private individual, is not able to issue a verifiable credential because the public key needed to verify the signature cannot be looked up on a public ledger conforming the SSI standards. There is also a problem that companies/avatars with public decentralized identifiers (DIDs) that issue credentials draw their authority or credibility from third party credentials that they need to produce the proof(s) that they claim to be who they are.

Credentials are a set of one or more claims made by an issuer. An issuer is an entity that asserts claims about one or more subjects, creating a verifiable credential from these claims, and transmits the verifiable credential to a holder. A holder is an entity that possesses one or more verifiable credentials and generates verifiable presentations from them. A holder is usually, but not always, a subject of the verifiable credentials they are holding. Credentials are used in a real world. A physical credential may include information related to identifying the subject of the credential (e.g., a photo, a name, an identification number, etc.), information related to the issuing authority (e.g., a city government, a national agency, a certification body, etc.), information related to the type of the credential (e.g., a passport, a driving license, a health insurance card, etc.), information related to specific attributes or properties being asserted by the issuing authority about the subject (e.g., nationality, the classes of vehicle entitled to drive, date of birth, etc.), evidence related to how the credential was derived, or information related to constraints on the credential (e.g., expiration date, terms of use, etc.).

A verifiable credential is a tamper-evident credential that has authorship that can be cryptographically verified. Verifiable credentials can be used to build verifiable presentations, which can also be cryptographically verified. The claims in a credential can be about different subjects. A verifiable credential can represent all of the same information that a physical credential represents. The advancement of technologies, such as digital signatures, makes verifiable credentials more tamper-evident and more trustworthy than their physical counterparts.

Holders of verifiable credentials can generate verifiable presentations and then share these verifiable presentations with verifiers to prove they possess verifiable credentials with certain characteristics. Verifiable presentation is data derived from one or more verifiable credentials, issued by one or more issuers, that is shared with a specific verifier. A verifier is an entity that receives one or more verifiable credentials, optionally inside a verifiable presentation for processing. A verifier may be referred to as a relying party. A verifiable presentation is a tamper-evident presentation encoded in such a way that authorship of the data can be trusted after a process of cryptographic verification. Certain types of verifiable presentations may contain data that is synthesized from, but do not contain, the original verifiable credentials (e.g., zero-knowledge proofs). At least one proof mechanism and the details necessary to evaluate that proof should be expressed for a credential or presentation to be a verifiable credential or verifiable presentation, that is to be verifiable.

A non-fungible token (NFT) is a non-interchangeable unit of data stored on a blockchain (a form of digital ledger) that can be sold and traded. An NFT may be associated with digital files, such as photos, videos, audio, etc. An NFT can have only one owner at a time. Ownership of an NFT is managed through a unique ID and metadata that no other token can replicate. NFTs are minted through smart contracts that assign ownership and manage the transferability of the NFTs. When someone creates or mints an NFT, they execute a code stored in a smart contract that conforms to a standard, such as ERC-721. This information is added to the blockchain where the NFT is being managed. The minting process, from a high level, has the following steps: creating a new block in the blockchain, validating information, and recording information into the blockchain.

NFTs have some special properties. Each NFT minted has a unique identifier that is directly linked to one cryptocurrency address (e.g., Ethereum address). NFTs are not directly interchangeable with other tokens 1:1. For example, one (1) Ether (ETH) is exactly the same as another ETH, but this is not the case with NFTs. Each NFT has an owner, and this information is easily verifiable. NFTs live on a blockchain (e.g., Ethereum) and can be bought and sold on any cryptocurrency-based NFT market. In other words, if somebody own an NFT, they can easily prove that they own it. Proving that somebody owns an NFT is very similar to proving that they have an ETH in their account. For example, if somebody purchases an NFT, the ownership of the unique token is transferred to his/her wallet via his/her public address. The token proves that their copy of the digital file is the original. The private key of a pair of asymmetric cryptographic keys associated with the token is a proof of ownership of the original.

A content creator may create a digital artifact and associate it with an NFT. The content creator's public key of a pair of asymmetric cryptographic keys may serve as a certificate of authenticity for that particular digital artifact. The creator's public key is essentially a permanent part of the token's history. The creator's public key can demonstrate that the token he/she holds was created by a particular individual, thus contributing to its market value (vs a counterfeit).

Another way of proving that you own an NFT is by signing a message to prove you own the private key behind the address of the NFT. The cryptocurrency address that holds the NFT token is derived from a public key. Therefore, a signed message by the corresponding private key can be verified with the public key. The public key itself can also be verified to see if the cryptocurrency address was derived from it. This proves that the signer owns the NFT because he/she who owns the private key owns the cryptocurrency token. The private key is a proof of ownership of the original. This means that the private key behind (i.e., associated with) the address of an NFT controls the NFT. A signed message using a private key can be used as a proof that you own your private key without revealing them to anybody and thus proving you own the NFT as well.

When somebody pays for an NFT, what he/she gets is the right to transfer the token to his/her digital wallet. The NFT proves that his/her copy of a digital file is the original, like owning an original painting. As masterpiece paintings can be copied and distributed as inexpensive posters, anyone can have a digital copy of the NFT. The private cryptographic key can be a proof of ownership of the original. The content creator's public cryptographic key may serve as a certificate of authenticity for a particular digital artifact. The pair of the creator's public key and the owner's private key is primarily what determines the value of any NFT token.

Every NFT has an owner, and this is of public record and easy for anyone to verify. One of the unique benefits of NFTs is the ability to track every transaction on the blockchain. Every NFT has an owner, creator, history, and this information or “provenance” is verifiable on blockchain. On each item's page, there is a section marked “Details” where details about the contract used to create it can be verified. Clicking it will reveal important information about the NFT, such as contract address of the collection, token ID of this particular NFT, blockchain the NFT resides on (e.g., Ethereum, Polygon, Klatyn, etc.), whether the NFT metadata is centralized or “Frozen”, or the like.

Decentralized identifiers (DIDs) are a new type of identifier that enables verifiable, decentralized digital identity. A DID refers to any subject as determined by the controller of the DID. DIDs are URIs that associate a DID subject with a DID document allowing trustable interactions associated with that subject. A DID subject is an entity identified by a DID and described by a DID document. Anything can be a DID subject, for example, a person, a group, an organization, a physical thing, a digital thing, a logical thing, etc. A DID document is a set of data describing the DID subject, including mechanisms, such as cryptographic public keys, that the DID subject or a DID delegate can use to authenticate itself and prove its association with the DID. Registering a DID is a process of creating a unique identifier on a distributed ledger and associating it with one or more public keys. You can prove you are the owner/controller of a DID to anyone you choose, as long as you possess the corresponding private key(s).

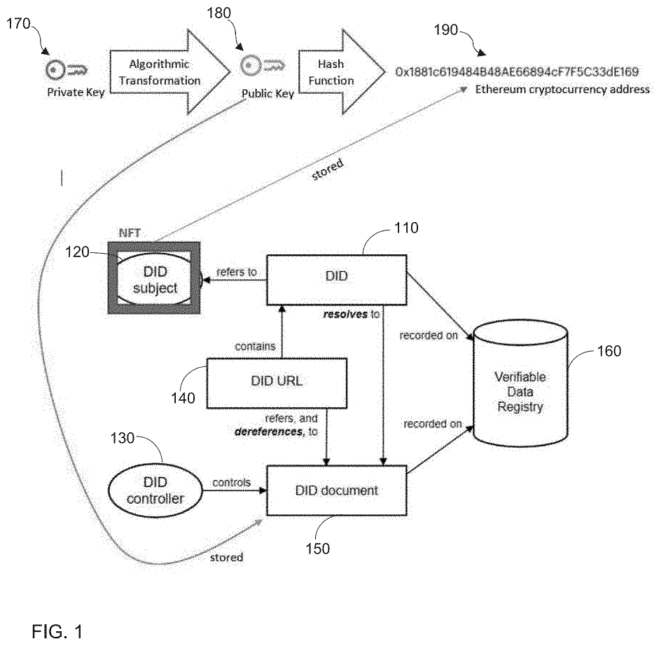

FIG. 1 illustrates an example process of verifying a user credential. A DID 110 refers to a DID subject 120 that a DID controller 130 decides that it refers to. The DID subject 120 may be any entity, for example, a person, a group, an organization, a physical thing, a digital thing, a logical thing, etc. In examples, the DID subject 120 may be an NFT. In the context of the present disclosure, a virtual representation of a user may have a self-sovereign identity (SSI) and may be the DID controller 130. An SSI is a scheme to digitally identify someone, which gives individuals control of their digital identities. The user may also have an SSI which differs from the SSI of the virtual representation of the user. The user may control his/her user DIDs which may differ from the DID 110.

The DID 110 may use a DID uniform resource locator (URL) 140 to associate the DID 110 with a DID document 150, extending the syntax of a basic DID 110 to incorporate other standard URL components such as path, query, and fragment to locate a particular resource, for example, a cryptographic public key inside a DID document 150, or a resource external to the DID document 150. In the same manner URLs in the web resolve to an Internet Protocol (IP) address, a DID URL 140 may resolve to a DID document 150. A DID 110 may allow trustable interactions associated with the DID subject 120 as the DID 110 as well as the DID document 150 may be recorded on a verifiable data registry 160. Non-limiting examples for a verifiable data registry 160 are distributed ledgers, decentralized file systems, decentralized databases of any kind, peer-to-peer networks, blockchains, and other forms of trusted data storage. For example, if the DID subject 120 is a private individual, the DID 110 and the DID document 150 may be recorded on a non-public verifiable data registry, such as a peer-to-peer network which may comprise a digital wallet of the DID controller 130 and/or a digital wallet of another entity involved in a data transaction with the DID controller 130. If the DID controller 130 is a virtual representation of a user, some DID 110 and DID document 150 may be stored on a public verifiable data registry, thus, the virtual representation of the user may be found by a third party by accessing the public verifiable data registry. In many cases, the DID controller 130 and the DID subject 120 may belong to the same entity. Since the generation and assertion of DIDs 110 is entity-controlled, each entity can have as many DIDs 110 as to maintain a desired separation of digital identities, digital personas, and interactions. The use of DIDs 110 can be scoped appropriately to different contexts. The DIDs 110 may support interactions with other entities via computer systems, when the interactions require a digital identification, and provide control over how much personal data should be revealed.

The DID document 150 may express a set of data, including attributes, describing the DID subject 120 as well as cryptographic material, verification methods, or service endpoints (core properties), which provide a set of mechanisms enabling the DID controller 130 to prove control of the DID 110 to the other entity. The cryptographic material may be used to prove certain aspects or attributes of a digital identity of the DID subject 120 by using a digital signature.

An example of a DID document, that the above-mentioned example of DID may resolve to, is provided below.

```
{
  “@context”: “https://www.example.did”,
  “id”: “did:example:123456789abcdefghi”,
  “verificationMethod”: [{
    “id”: “did:example:123#_Qq0UL2Fq651Q0Fjd6TvnYE-faHiOpRlPVQcY_-tA4A”,
    “type”: “JsonWebKey2020”,
    “controller”: “did:example:123”,
    “publicKeyJwk”: {
      “crv”: “Ed25519”,
      “x”: “VCpo2LMLhn6iWku8MKvSLg2ZAoC-nlQyPVQaO3FxVeQ”,
      “kty”: “OKP”,
      “kid”: “_Qq0UL2Fq651Q0Fjd6TvnYE-faHiOpRlPVQcY_-tA4A”
    }
}],
“credentialSubject”: {
    “id”: “did:example:123”,
    “givenName”: “JOHN”,
    “familyName”: “SMITH”,
    “gender”: “Male”,
    “image”: “data:image/png”,
    “birthCountry”: “Bahamas”,
    “birthDate”: “1958-08-17”
      },
  },
}
```

In the example shown above, the DID document 150 may include verification material. Verification material is any information that is used by a process that applies a verification method. The type of a verification method may be expected to be used to determine its compatibility with such processes. The above example uses publicKeyJwk as verification method type which may correspond to an Internet Engineering Task Force (IETF) specification. A verification suite may be responsible for specifying the verification method type and its associated verification material. The publicKeyJwk may represent a public key as JavaScript Object Notation (JSON) Web Key with an “Ed25519” curve. The curve's “x” coordinates and key type parameter “kty” may be base64ur1-encoded values as shown. The verification method that uses JSON Web Keys may use the value of “kid” as key fragment identifier. Other types of verification methods may be used in other examples. Embodiments may not be restricted to a certain syntax or to certain properties of DID document.

The DID document 150 may indicate a public key 180, as shown in the example above. The public key 180 may be part of an asymmetric cryptographic key pair according to public key cryptography, or asymmetric cryptography. The asymmetric cryptographic key pair may comprise a public key 180 which may be known to others, and a private key 170 which may not be known by anyone except the owner. Effective security may require keeping the private key 170 secret, while the public key 180 can be openly distributed without compromising security. Such asymmetric cryptographic key pairs may be generated based on cryptographic algorithms which may belong to mathematical problems termed one-way functions. A one-way function may be a function that is easy to compute on every input, but hard to invert given the image of a random input. Here, “easy” and “hard” may be understood in the sense of computational complexity theory, specifically the theory of polynomial time problems.

Public key algorithms may be fundamental security primitives in modern cryptosystems, including applications and protocols which offer assurance of the confidentiality, authenticity and non-repudiability of electronic communications and data storage. Such cryptosystems may underpin numerous Internet standards, such as Transport Layer Security (TLS), S/MIME, PGP, and GPG. Some public key algorithms may provide key distribution and secrecy, e.g., Diffie-Hellman key exchange, some may provide digital signatures, e.g., Digital Signature Algorithm, and some may provide both, e.g., RSA.

In the example shown above, the DID document 150 may include attributes, such as “givenName”, “familyName”, “gender”. The attributes may belong to a DID subject, such as a virtual representation of a user. In this case, the attributes are part of a credential. The attributes may be inherited from the user. In other embodiments, attributes may be created by the user, or created by a third party, or inherited from a third party.

A cryptocurrency address 190 (e.g., Ethereum cryptocurrency address) is created from a public key 180. The first step to generate the cryptocurrency address 190 is to create a random private key 170 using SHA256, for example, using an open-source Ethereum library. Private keys are generated as random 256 bits, which is 64 (hex) characters or 32 bytes. A private key is only known to the user who created it either through a library or cryptographic hash functions. The private key 170 may be used to sign transactions (e.g., Ethereum transactions) on the blockchain.

After generating the private key 170, a public key 180 (128 characters/64 bytes) is created using an algorithm called Elliptic Curve Digital Signature Algorithm (ECDSA). Ethereum uses secp256k1 to generate public keys. The public key 180 corresponds to the private key 170 created using the cryptographic functions. Public keys can be created using private keys, but private keys cannot be created from public keys.

In order to create an Ethereum address, Keccak256 algorithm (Ethereum hash function) is applied to the public key 180, which generates a string of 32 bytes. The last 20 bytes (or 40 characters) of this string (Keccak-256) are taken, (i.e., the first 12 bytes are dropped) as an Ethereum address. When prefixed with Ox it becomes 42 characters long.

In examples, an owner of an NFT may sign a credential using a private key 170 associated with the NFT and send the signed credential to other entity/entities. The private key 170 associated with the cryptocurrency address 190 holding an NFT is used to sign the verifiable credential issued by the owner of the NFT. A signature by which the verifiable credential is signed may be verified using the matching public key 180. The owner of the NFT assigns a public DID to the NFT and registers this public DID on a public ledger 160 so that anyone can look up this public DID. The public key 180 is put in a DID document 150 that is placed on a public ledger. The public key 180 is inside the DID document 150 that is stored together with the public DID on a public ledger. This DID document 150 may be found by looking up the corresponding public DID of the NFT that signed the verifiable credential.

Current NFT owners can be looked up publicly to obtain the cryptocurrency address that holds the NFT token. The owner of an NFT may create a public DID for the NFT to allow a lookup of the DID on a public ledger. The owner of the NFT may assign a public DID to the NFT and register this public DID on a public ledger so that anybody can look up this public DID. The DID document associated with the public DID contains the public key from which the cryptocurrency address holding the NFT token can be derived.

Any interested parties can easily check whether the cryptocurrency address 190 holding the NFT token is derived from the public key 180 (the public key that matches the private key used to sign the credential). The interested parties can verify that the signature on the verifiable credential was made by the owner of the NFT by checking whether the cryptocurrency address 190 holding the NFT is derived from the matching public key. The cryptocurrency address can be derived from the public key only if a transaction (the signed credential) has been sent from the owner of the NFT of the specific cryptocurrency address. The public key from which the cryptocurrency address is derived is not known until a transaction has been sent from that cryptocurrency address. For an NFT, this means that the NFT token should be part of a transaction which implies that the NFT token will be sent to a new address. For this new address the public key will again be not known. Therefore, in examples, this is not a useful technique to find out what is the public key of the NFT. In examples disclosed herein, the public key from which the cryptocurrency address was derived is put inside the DID document that corresponds with the public DID. This allows anybody to lookup the public register through the public DID that was assigned to the NFT. Once the public key is known, the public key can be used to verify the signature of the issued credential, and to verify that the NFT cryptocurrency address can be derived from this public key to make sure that the NFT is authentic.

With this scheme, the NFT would be its own authority because it would no longer need any other third-party credentials to legitimize itself. The public key associated with the NFT can guarantee that the owner of the NFT is who he/she claims to be. By having an NFT-issued verifiable credentials, the NFT is considered to be an authority that does not need to get its validity derived from third party-verifiable credentials because its authenticity can be checked on the spot with the public key and the derived cryptocurrency address.

In examples, an owner of an NFT identified by a public DID may issue a verifiable credential that is signed using the private key associated with the cryptocurrency address holding the NFT token. The owner of the NFT assigns a public DID to the NFT and registers this public DID on a public ledger so that anybody can look up this public DID. The corresponding public key used to derive the cryptocurrency address is disclosed in the DID document that can be resolved from the public DID that is associated with the NFT. Anyone can use the public key to verify the verifiable credential signature. Anyone that looked up the cryptocurrency address holding the NFT can verify if this cryptocurrency address can be derived from the public key.

When an NFT is sold, the NFT is transferred to the cryptocurrency address of the buyer who now becomes a new owner. The new cryptocurrency address of the new owner has a different public and private key pair. This makes the DID of the NFT deprecated.

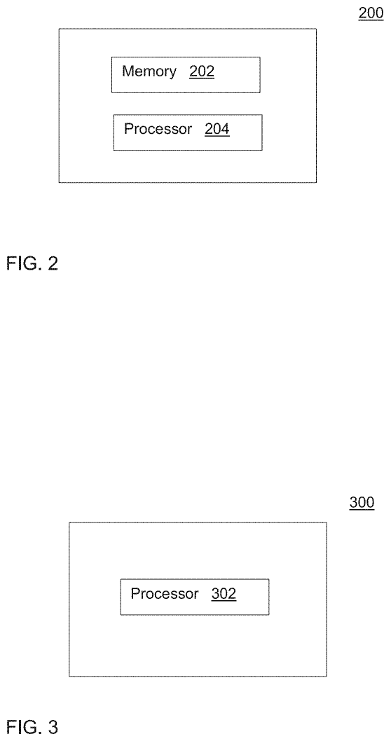

FIG. 2 is a schematic block diagram of an apparatus 200 for verifying user credentials in accordance with one example. The apparatus 200 includes a memory 202 and a processor 204. The memory 202 may be configured to store a cryptographic private key of a public key infrastructure (PKI). The private key is associated with a cryptocurrency address holding an NFT. The processor 204 may be configured to sign a verifiable credential with the private key and issue the verifiable credential signed with the private key to another entity/entities.

The owner of the NFT may assign a public DID to the NFT and registers the public DID on a public ledger so that anyone can look up this public DID on the public ledger. The NFT can be identified by the public DID of the NFT. The matching cryptographic public key corresponding to the private key is disclosed in a DID document associated with the public DID. Therefore, anyone can obtain the matching public key from the DID document and verify the credential using the public key.

FIG. 3 is a schematic block diagram of an apparatus 300 for verifying user credentials in accordance with one example. The apparatus 300 includes a processor 302. The processor 302 may be configured to receive a verifiable credential that is signed using a private key of a PKI, obtain a public key corresponding to the private key, and verify the verifiable credential using the obtained public key. The private key is associated with a cryptocurrency address holding an NFT.

The owner of the NFT assigns a public DID to the NFT and registers the public DID on a public ledger, so that anyone can look up this public DID on the public ledger. The processor 302 is configured to determine a DID document based on the public DID of the NFT and obtain the public key from the DID document. The processor 302 may verify the verifiable credential using the obtained matching public key. The verifiable credential may be verified if the cryptocurrency address holding the NFT can be derived from the obtained matching public key.

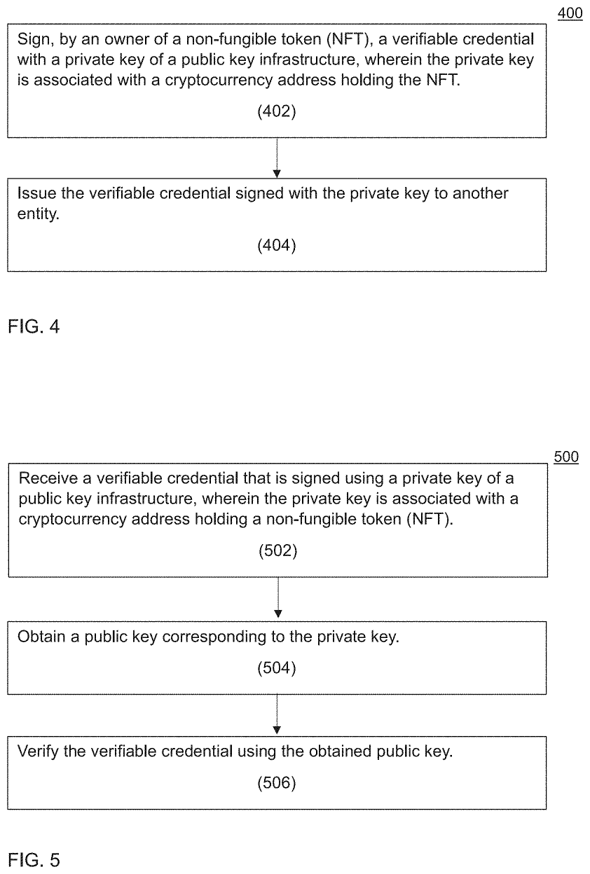

FIG. 4 is a flow diagram of an example method for verifying user credentials. The method 400 includes signing, by an owner of an NFT, a verifiable credential with a private key of a public key infrastructure (402). The private key is associated with a cryptocurrency address holding the NFT. The method 400 includes issuing the verifiable credential signed with the private key to another entity (404). The owner of the NFT assigns a public DID to the NFT and registers the public DID on a public ledger, and the NFT is identified by the public DID. A public key corresponding to the private key that is used to sign the verifiable credential is disclosed in a DID document associated with the public DID. The cryptocurrency address may be an Ethereum address.

FIG. 5 is a flow diagram of an example method for verifying user credentials. The method includes receiving a verifiable credential that is signed using a private key of a public key infrastructure associated with a cryptocurrency address holding an NFT (502). The method includes obtaining a public key corresponding to the private key (504). The method includes verifying the verifiable credential using the obtained public key (506).

The owner of the NFT assigns a public DID to the NFT and registers the public DID on a public ledger. The method further includes resolving the public DID of the NFT to a DID document and obtaining the public key from the DID document. The verifiable credential may be verified if the cryptocurrency address holding the NFT can be derived from the public key. The cryptocurrency address may be an Ethereum address.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for verifying user credentials. The method may include signing, by an owner of an NFT, a verifiable credential with a private key of a public key infrastructure, wherein the private key is associated with a cryptocurrency address holding the NFT. The method may also include issuing the verifiable credential signed with the private key to another entity.

Another example (e.g., example 2) relates to a previously described example (e.g., example 1), wherein the owner of the NFT assigns a public DID to the NFT and registers the public DID on a public ledger, and the NFT is identified by the public DID.

Another example (e.g., example 3) relates to a previously described example (e.g., example 2), wherein a public key corresponding to the private key is disclosed in a DID document associated with the public DID.

Another example (e.g., example 4) relates to a previously described example (e.g., any one of examples 1-3), wherein the cryptocurrency address is an Ethereum address.

Another example (e.g., example 5) relates to a method for verifying user credentials. The method may include receiving a verifiable credential that is signed using a private key of a public key infrastructure, wherein the private key is associated with a cryptocurrency address holding an NFT. The method may further include obtaining a public key corresponding to the private key. The method may further include verifying the verifiable credential using the obtained public key.

Another example (e.g., example 6) relates to a previously described example (e.g., example 5), wherein an owner of the NFT assigns a public DID to the NFT and registers the public DID on a public ledger. The method further includes resolving the public DID of the NFT to a DID document and obtaining the public key from the DID document.

Another example (e.g., example 7) relates to a previously described example (e.g., example 6), wherein the verifiable credential is verified if the cryptocurrency address holding the NFT can be derived from the public key.

Another example (e.g., example 8) relates to a previously described example (e.g., any one of examples 5-7), wherein the cryptocurrency address is an Ethereum address.

Another example (e.g., example 9) relates to an apparatus for verifying user credentials. The apparatus may include a memory configured to store a private key of a public key infrastructure, wherein the private key is associated with a cryptocurrency address holding an NFT. The apparatus may include a processor configured to sign a verifiable credential with the private key, and issue the verifiable credential signed with the private key to another entity.

Another example (e.g., example 10) relates to a previously described example (e.g., example 9), wherein an owner of the NFT assigns a public DID to the NFT and registers the public DID on a public ledger, and the NFT is identified by the public DID of the NFT.

Another example (e.g., example 11) relates to a previously described example (e.g., example 10), wherein a public key corresponding to the private key is disclosed in a DID document associated with the public DID.

Another example (e.g., example 12) relates to an apparatus for verifying user credentials. The apparatus may include a processor configured to receive a verifiable credential that is signed using a private key of a public key infrastructure, obtain a public key corresponding to the private key, and verify the verifiable credential using the obtained public key, wherein the private key is associated with a cryptocurrency address holding an NFT.

Another example (e.g., example 13) relates to a previously described example (e.g., example 12), wherein an owner of the NFT assigns a public DID to the NFT and registers the public DID on a public ledger, wherein the processor is configured to determine a DID document based on the public DID of the NFT and obtain the public key from the DID document.

Another example (e.g., example 14) relates to a previously described example (e.g., example 13), wherein the verifiable credential is verified if the cryptocurrency address holding the NFT can be derived from the public key.

Another example (e.g., example 15) relates to a machine-readable storage medium including codes, when executed, to cause a machine to perform a method as in any one of examples 1-8.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub—acts, -functions, -processes, -operations or —steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A method for verifying user credentials, comprising:
signing, by an owner of a non-fungible token (NFT), a verifiable credential with a private key of a public key infrastructure, wherein the private key is associated with a cryptocurrency address holding the NFT; and
issuing the verifiable credential signed with the private key to another entity.

2. The method of claim 1, wherein the owner of the NFT assigns a public decentralized identifier (DID) to the NFT and registers the public DID on a public ledger, and the NFT is identified by the public DID.

3. The method of claim 2, wherein a public key corresponding to the private key is disclosed in a DID document associated with the public DID.

4. The method of claim 1, wherein the cryptocurrency address is an Ethereum address.

5. A method for verifying user credentials, comprising:
receiving a verifiable credential that is signed using a private key of a public key infrastructure, wherein the private key is associated with a cryptocurrency address holding a non-fungible token (NFT);
obtaining a public key corresponding to the private key; and
verifying the verifiable credential using the obtained public key.

6. The method of claim 5, wherein an owner of the NFT assigns a public decentralized identifier (DID) to the NFT and registers the public DID on a public ledger, the method further comprising:
resolving the public DID of the NFT to a DID document; and
obtaining the public key from the DID document.

7. The method of claim 6, wherein the verifiable credential is verified if the cryptocurrency address holding the NFT can be derived from the public key.

8. The method of claim 5, wherein the cryptocurrency address is an Ethereum address.

9. An apparatus for verifying user credentials, comprising:
a memory configured to store a private key of a public key infrastructure, wherein the private key is associated with a cryptocurrency address holding a non-fungible token (NFT); and
a processor configured to sign a verifiable credential with the private key, and issue the verifiable credential signed with the private key to another entity.

10. The apparatus of claim 9, wherein an owner of the NFT assigns a public decentralized identifier (DID) to the NFT and registers the public DID on a public ledger, and the NFT is identified by the public DID of the NFT.

11. The apparatus of claim 10, wherein a public key corresponding to the private key is disclosed in a DID document associated with the public DID.

12. An apparatus for verifying user credentials, comprising:
a processor configured to receive a verifiable credential that is signed using a private key of a public key infrastructure, obtain a public key corresponding to the private key, and verify the verifiable credential using the obtained public key,
wherein the private key is associated with a cryptocurrency address holding a non-fungible token (NFT).

13. The apparatus of claim 12, wherein an owner of the NFT assigns a public decentralized identifier (DID) to the NFT and registers the public DID on a public ledger,
wherein the processor is configured to determine a DID document based on the public DID of the NFT and obtain the public key from the DID document.

14. The apparatus of claim 13, wherein the verifiable credential is verified if the cryptocurrency address holding the NFT can be derived from the public key.

15. A machine-readable storage medium including codes, when executed, to cause a machine to perform a method in claim 1.
